(19) United States
(12) Patent Application Publication
(10) Pub. No.: US 2011/0302422 A1
(43) Pub. Date: Dec. 8, 2011

(54) HASH FUNCTION USING A REPEATED FUNCTION WITH SHIFTS

(75) Inventors: Augustin J. Farrugia, Cupertino, CA (US); Benoit Chevallier-Mames, Paris (FR); Mathieu Ciet, Paris (FR)

(73) Assignee: Apple Inc., Cupertino, CA (US)

(21) Appl. No.: 12/792,633

(22) Filed: Jun. 2, 2010

(51) Int. Cl. H04L 9/32

(52) U.S. Cl. 713/181

(57) ABSTRACT

In the data security field, a modular cryptographic hash function process is embodied in a computer system or hardware (circuitry). The process is based on the mode of operation of the known “Shabal” hash function which uses a keyed permutation applied to each word of the message. Here a function is substituted for the permutation and additional final rounds are added to the function. Security is further enhanced over that of the Shabal hash function by avoiding use of the message blocks in computing certain of the data arrays, in order to frustrate known message attacks.

### FIELD OF THE INVENTION

This invention relates to computing, communications, data security, and hash functions (hashing).

### BACKGROUND

Hash functions are well known in the field of data security. The principle is to take data (a digital message, digital signature, etc.) and use it as an entry to a hash function resulting in an output called a “digest” of predetermined length which is intended to uniquely identify (“fingerprint”) the message. A secure (cryptographic) hash is such that any alteration in the message results in a different digest, even though the digest is much shorter than the message. Secure hash functions are also collision-resistant and one-way and preimage and second preimage resistant.

Cryptography and data security deal with digital signatures, encryption, document authentication, and hashing. In all of these fields, there is a set of basic tools/functions which are widely used, for instance hash functions. Several properties are required for the use of hash functions in cryptographic applications: preimage resistance, second preimage resistance and collision resistance.

In the recent years, much energy has been expended finding new hash functions, since collisions (weaknesses or successful attacks) have been found in the widely used SHA-0/1 and MD-5 standard hashes.

In cryptography, hash functions are essential for many primitives and protocols. After the above mentioned security crisis for MD5 and SHA-0/1, two hash standards used for a long time without much concern about their security, the U.S. NIST (National Institute of Standards and Technology) launched an international competition to define the new standard for hash functions. The competition started in 2008. Amongst the competitors, many were broken easily in the first round, since the developers were not aware of the cryptographic issues. In the remaining submissions of the second round, one called “Shabal” is one of the fastest-running (in terms of execution time) submissions.

Shabal has two parts: there is a mode of operation (see the published Shabal specification at: http://www.shabal.com/wp-content/uploads/Shabal.pdf, at Sec. 2.2), which is defined for a sufficiently secure permutation or function; and there is a proposed permutation designated P itself, described in Sec. 2.32 of the same document.

Certain cryptanalyses have been proposed following the NIST competition, which do not break Shabal hash function, but show a certain non-randomness of the permutation P (see http://ehash.iaik.tugraz.at/wiki/Shabal).

Shabal makes use of three 32-bit word arrays designated A, B and C shown in FIG. 1. The initial values of arrays A, B and C can be computed or tabulated. There is a counter designated W initially set to 0. The input message is divided into blocks each designated M. For each successive message block Mᵢ, the counter value W is incremented, the counter value is logically XOR'd (logical exclusive OR) with array A, Mᵢ is added to array B, the permutation P is applied to (A,B) with parameters Mᵢ and C to get new values of (A,B), Mᵢ is subtracted from C, and finally B and C are exchanged as shown in FIG. 1. This process is further detailed and proven secure in the Shabal specification.

When the last block of message Mₖ has been processed, the process arrives at what is called the final rounds (see FIG. 2). The final rounds apply the P permutation last round 3 times, on the last message block Mₖ. Finally, the H (hash) value is extracted from array B, as shown in FIG. 2.

The size of the A, B. C, and M can be changed; the Shabal developers proposed B, C, M of 16 32-bit words, and A of 12 32-bit words.

### SUMMARY

Disclosed here is a new cryptographic (secure) hash function or process. The goal is a highly modular hash function that is also computationally efficient. The present hash function can conventionally be used for document integrity for exchanges and signatures. It can be also used as a derivation function or as a HMAC (hash message authentication code) by adding a key conventionally (as in for instance the well known HMAC-SHA1) and the term “hash” as used herein is intended to encompass all these uses, both keyed and non-keyed.

A hash function is a deterministic procedure that accepts an arbitrary input value, and returns a hash value. The input value is called the message, and the resulting output hash value is called the digest. The message is authenticated by comparing the computed digest to an expected digest associated with the message.

Thus disclosed here is a new function using in one embodiment the Shabal mode of operation.

The presently disclosed exemplary embodiments use the Shabal mode of operation, since it is quite natural, simple and has been proven secure. Some of the present modifications to Shabal are in the definition of the permutation P. In their specification, the Shabal developers tried to be efficient for both hardware (e.g., dedicated integrated circuits such as FPGA or ASIC) and software implementations, and to avoid using too much memory, in order to be practical to be embedded as hardware in low-cost devices such as smart cards or RFID. Being efficient in that way is less of a concern here. Furthermore, the first year of external cryptanalysis showed weaknesses in the current Shabal P permutation. The present P function is believed to be free of these defects. Finally, the present hash function uses a function instead of a permutation, and is also compatible with the Shabal mode of operation. A function is not necessarily a permutation; a permutation is invertible, while a function may be noninvertible.

### BRIEF DESCRIPTION OF THE FIGURES

FIGS. 1 and 2 depict graphically the known “Shabal” hash function.

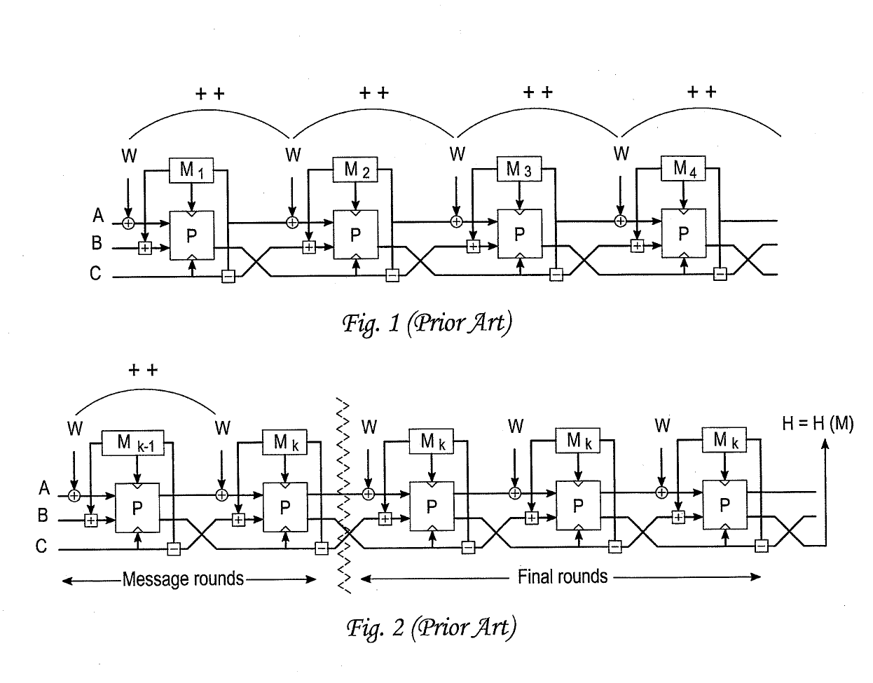

FIG. 3 shows a set of variables and parameters as used here.

FIG. 4 shows relevant portions of a computing apparatus for carrying out the present method.

FIG. 5 shows additional detail of the FIG. 4 computing apparatus.

### DETAILED DESCRIPTION

In the present hash function, A, B, C and M are each 32 32-bit word arrays (i.e., 1024 bits). Having such large blocks has certain advantages (a security parameter called the ‘capacity’ is larger in this case than in Shabal), but at the same time, it is more complicated to build a sufficiently random function when the blocks are large. To minimize this difficulty, the present hash function uses a relatively large security parameter for the hash function, and may include more than 3 blank (final0 rounds at the end.

For the present P function, one goal is to make array A very hard for the user (e.g., an attacker) to control; notably, the user cannot insert directly message words into array A, since here the modifications of array A are only performed indirectly through modifications of the other arrays. This increases security against such known message attacks. Note that an attacker typically manipulates inputs to find collisions, which means breaking the hash function using a known message approach.

The new P function is as follows, expressed in computer software pseudo-code for ease of understanding: (This is conventionally similar to actual code but less detailed and not executable.) This P function includes (1) pre-steps, (2) left shift steps, and (3) final steps, per the comments set forth by the notation /* and */. This P function is used in the Shabal mode of operation explained above, in place of the Shabal P permutation.

```
Input: M, A, B, C
Output: A, B
/* Pre-steps */
For i from 0 to 31, do:
  B[i] = (B[i] \hat{ } K[i]) + V(C[i])
  A[i] = A[i] + U(B[i])
Next i
/* LFSR-style steps */
For j from 1 to SecPar, do:
  For i from 0 to 31, do:
    A[(i + 3j) mod 32] = Y(
              A[ (i +3j) mod 32] \hat{ }
              ROT_LEFT (Z (A[ (i + 3j − 5) mod 32] ), 7) \hat{ }
              C [ (3i + j + 1) mod 32]
            )
            \hat{ } B [i + o1 mod 32]
            \hat{ } (B [i + o2 mod 32] && NOT (B[i + o3 mod 32]))
    B [i] = ROT_LEFT (B [i], j)
      \hat{ } X (ROT_LEFT (M[(i+j) mod 32],2*j) \hat{ } KK [A[ (i + 3j) mod 32] mod 257])
    Next i
Next j
/* Final steps */
For i from 0 to 31, do:
  B [i] = B[i] + V(A[i])
  A [i] = A[i] + U(B[i])
Next i
where
      (o1 , o2, o3) are offsets. E.g., (27, 21, 11).
      SecPar is a security parameter. E.g., 12.
      K is a table of 32 32-b constants. E.g.,
        K[32] =
        (
```

| | | | | | | |
|---|---|---|---|---|---|---|
| 0xD510F51F, | 0x6AC25F70, | 0x5F485ADC, | 0xC557C783, | 0x6DE54C4B, | 0x6B032C5F, | 0x97A58FDC, |
| 0x6E50D1DF, | 0x9CF5148F, | 0x64B8EBF7, | 0x07CB0CBF, | 0x14C06D8D, | 0xE348F99A, | 0x75192606, |
| 0x574476AE, | 0x29ADB325, | 0x58D82FA0, | 0x8D2A56EB, | 0x5EF13FSB, | 0x8A7914C3, | 0x1E092450, |
| 0xF7F58764, | 0x76E5D648, | 0x11F9DAFC, | 0x25E46DCD, | 0xC1910ECB, | 0x0683B998, | 0x9C14659C, |
| 0xEA63E888, | 0x44860E66, | 0x623D4A0A, | 0x3FAF6EDD, | | | |

```
        );
KK is a table of 257 32-b constants. E.g.,
        KK[257] =
        (
```

| | | | | | | |
|---|---|---|---|---|---|---|
| 0x9D87ECCD, | 0xE8F0D628, | 0xA098BD24, | 0x829A014D, | 0x6600A63C, | 0xE6BB5BFF, | 0xA951FCC9, |
| 0x4EF79464, | 0xB879E62F, | 0xF6773415, | 0xD8DB9075, | 0x5CEBD248, | 0x84D3A981, | 0x582214FF, |
| 0x788A196D, | 0x53CBD375, | 0x893578F5, | 0xF870F9E0, | 0x6B19246F, | 0x144D40D6, | 0x9C8309FC, |
| 0xDDB28D69, | 0xA0C3372A, | 0x0EAE4C13, | 0xB7DC135A, | 0xB38B94C3, | 0x3204AFC1, | 0x4199377C, |
| 0x63B43552, | 0x894AE0AB, | 0xE6ACBBE8, | 0x99B76637, | 0xCF49BE38, | 0xF24A7143, | 0xB76BC4D7, |
| 0xD13DE72D, | 0x3FCA1227, | 0x2FC1A523, | 0xFD39B7B8, | 0xFDEB8A56, | 0x4E018F66, | 0x03DDAA8E, |
| 0x744D4B89, | 0x20BC12BE, | 0x4003D52C, | 0xFCD9E26A, | 0x1CDC1FA3, | 0xFED88853, | 0xB0668835, |
| 0x5B93A75C, | 0x43EEFF51, | 0x2353E608, | 0x93EB581C, | 0x2A999524, | 0x0CF54285, | 0xA4AEAEDD, |
| 0x5C794A46, | 0x5FF50301, | 0xFF8FEBE4, | 0xE374D8C2, | 0x2220A1B4, | 0xF41DEA56, | 0xCFCE9933, |
| 0x36891086, | 0xDF05965D, | 0x6FDDFF3F, | 0x33290C59, | 0xF4DEB237, | 0x4F67CBFD, | 0xB30303E8, |
| 0x88601606, | 0x068BC8A8, | 0xA9DC56DD, | 0xEAF3E5D9, | 0xEE87DD2C, | 0x52795912, | 0xA99404F4, |
| 0xF763C22E, | 0xDD7F3D8B, | 0xEF8D4FCA, | 0x07FA7D20, | 0x7D3C2CD3, | 0x66B34C0C, | 0xE0927816, |
| 0xB791FF86, | 0x3EADE211, | 0xD71146C6, | 0xA2A7A4AS, | 0x0525343F, | 0xF49A3710, | 0x2AC35B3C, |
| 0x19928E77, | 0x4BF1A5BC, | 0x348D5640, | 0x5CF0E659, | 0x8CEE0B0A, | 0xFDC85A2F, | 0xAEFA8391, |
| 0x383B91CC, | 0x1E20C5F6, | 0xA8CB39D7, | 0x4B260654, | 0xCDEDF6BE, | 0x47CCB053, | 0xDA5BCBE4, |
| 0xC08CD360, | 0x4098A843, | 0xD80CBF32, | 0x71487C85, | 0x3DEFE473, | 0x47614849, | 0xAADEBC9A, |
| 0x64D38878, | 0x678BF559, | 0xC05A950B, | 0x91C14883, | 0x3954EE9A, | 0x73B716B2, | 0x43DBB162, |
| 0xBDB76AF2, | 0x3AEF2F2C, | 0x39A33AB2, | 0xC4F5497A, | 0x2F8247FB, | 0x7E9356FB, | 0x0A566A7F, |
| 0x70435EF0, | 0x61A1B7C6, | 0x9DA98FDA, | 0xCC322D0E, | 0x8E64B018, | 0xD20DD312, | 0x808AC79B, |
| 0xE68AB65C, | 0xAB382635, | 0xA445619B, | 0x3274CF08, | 0xBCCDF3A3, | 0x028BA124, | 0x2908DB04, |
| 0x8F52A4DA, | 0x96F56E68, | 0xBD996BE9, | 0xE606A672, | 0x032049C8, | 0x86D8516C, | 0xF8EC47B6, |
| 0xA7C15C52, | 0x7BD80477, | 0xE250E3E5, | 0xDAFDAB7F, | 0x07D9D70B, | 0xA2D957B9, | 0xD72C8C35, |
| 0x6797450B, | 0x98DF2865, | 0x5E2E22DC, | 0xDBD33519, | 0x2F1D8192, | 0x601AFD3B, | 0xD3972410, |
| 0xF159AE61, | 0xCD81EAE0, | 0xEBC4B02B, | 0x28C28045, | 0x248CF09A, | 0x96823B84, | 0xFDDFC76A, |
| 0xA486C767, | 0xD892A230, | 0x1D8F2421, | 0x389F4708, | 0x420419FC, | 0x860FCF07, | 0xA905A9E5, |
| 0x683FC0CE, | 0x8010CFBD, | 0xE63B1B3F, | 0xB33FCF11, | 0xF0594BAF, | 0xD7701822, | 0xDBE810FE, |
| 0x15E7BB40, | 0x2899C5F4, | 0x37DB0EED, | 0xA8D2F275, | 0x31F4C22C, | 0xDE33D250, | 0xF34C7C69, |
| 0x2337AB89, | 0x192D4A22, | 0x51A240E2, | 0xD282E55F, | 0x6D48FA88, | 0x73764C12, | 0xECD86E62, |
| 0x4758E246, | 0x7EB4CA94, | 0x16021350, | 0x82313046, | 0x7CB16EB4, | 0x14365AA0, | 0x36514753, |
| 0xD462485C, | 0x877DFB5D, | 0x3F978834, | 0xA4C9B262, | 0x93D0F891, | 0xE3A24C27, | 0xBCCDFA22, |
| 0xB957325C, | 0xDA47AB94, | 0xD0B59ECC, | 0x98340AF7, | 0x15294AB0, | 0xD6CC450C, | 0x217591AF, |
| 0x3D367EE6, | 0x8E09A46A, | 0x89C67008, | 0x944F6D67, | 0xCD289DA6, | 0xFF1EAB56, | 0xBB3868CD, |
| 0x308E56A6, | 0x9AEE5A5B, | 0xD8CA29A4, | 0x1883B0C8, | 0x62D77FC9, | 0x24B3E74B, | 0xD80F1F94, |
| 0x8BD0EF45, | 0x5BE511E1, | 0xE2130E09, | 0x7BA2180E, | 0x33DA7C26, | 0xE07D37C6, | 0xAB6406ED, |
| 0xEDAFEF38, | 0x380F9D86, | 0x0FC923E6, | 0xBB3BB530, | 0xA9B95B2E, | 0x385FCD57, | 0xB7E71E5F, |
| 0x1667E117, | 0x49486155, | 0x554BE0B0, | 0xC154ACCA, | 0x593691BB, | 0xE916FEFF, | 0x4E71C28A, |
| 0x0D96E0C1, | 0xA94FD66D, | 0xC36DD74C, | 0xF623C4E8, | 0x03404182 | | |

```
        );
      ROT_LEFT (x,b) means the left rotation of 32-b word x by b bits.
      NOT (x) is the bit-to-bit inverse (i.e., x \hat{ } 0xffffffff).
      U ( ), V ( ), X ( ), Y ( ), Z ( ) are 32-b multiplications by odd constants. E.g.,
          U(x) = (0x88930819 * x) & 0xffffffff;
          V(x) = (0x0EE517C5 * x) & 0xffffffff;
          X(x) = (0x8F731C61 * x) & 0xffffffff;
          Y(x) = (0x9CC3EB57 * x) & 0xffffffff;
          Z(x) = (0x9A1BC45F * x) & 0xffffffff;
```

Here operator “̂” indicates the XOR (exclusive OR) logical operation. “mod” indicates modulo. The prefix “0x” indicates a hexadecimal number. Operator “&” indicates the Boolean logic bit-by-bit AND operation.

The following per the pseudo-code is done in the pre-steps of function P different than in the Shabal P permutation:
(1) Modifying arrays A and B, without message M, which of course is completely under the control of the user.
(2) Apply a XOR operation on array B (with a constant), whereas in Shabal array B is updated with an addition (thus, XOR ‘separates’ the addition from the next U( ) call).
(3) Use non linear U( ) and V( ) functions and addition.

The following is done in the P function left shift steps different than in the Shabal P permutation. Here the P function uses the LFSR-operation as in the Shabal P permutation, but with several possible modifications (depending on the embodiment) listed immediately below to make the P function more secure:
(1) no insertion of the message blocks in array A, so as to make array A hard to directly control by the user (e.g., an attacker)
(2) the order of modification of array A depends on index j
(3) the bit rotation of array B depends on index j
(4) the update of array B depends on message M now, with bit rotations that depend on index j
(5) Logical XOR of message M with constants in array B updated before the call to function X, to ensure that the additive differential of the message blocks are different from those of array B before applying function P. The constants are chosen from a table from the previously computed array A value mod 257. Using the previous array A value desirably makes computation of differential paths more complicated; using 257-size tables instead of power-of-2 size makes that the value depends on all bits of the word. (This may be useful to avoid XOR-differential attacks).

The following is done in the final steps of the P function different than in the P permutation in Shabal:
(1) Modifying arrays A and B, without reference to message M, which is under the control of the user.
(2) Use non linear U( ) and V( ) functions and add, to provide more non-linearity.

Two other possible modifications of the Shabal P permutation used in the present P function are the following:
(1) Select the IV (initial values) for arrays A, B, and C (designated AO, BO, CO) different from that of Shabal, e.g. let:

A0[32] =
(

| | | | | | | |
|---|---|---|---|---|---|---|
| 0x664288B8, | 0xB43B1786, | 0x2737924C, | Ox13B18C88, | 0xF1617F45, | 0xFE4839D3, | 0xA6ACA452, |
| 0xCD5FEDDE, | 0xBB2E2DFF, | 0x46437B05, | 0xA238CDF1, | 0x48C62922, | 0x9190250E, | 0x143DD78F, |
| 0x40657C62, | 0xA0468308, | 0xB9F551BF, | 0x0D78DF87, | 0x1894F4F3, | 0x0DC633B6, | 0x4F808EE2, |
| 0xB2F3F819, | 0x7EDB874A, | 0xBB5DD7BA, | 0x253C730D, | 0x0101A499, | 0x8D9FBF52, | 0x9D69CAE3, |
| 0xF25CEDAC, | 0x4040ABB3, | 0xC1AD4A5C, | 0x46ACA778 | | | |

) ;
B0[32] =
(

| | | | | | | |
|---|---|---|---|---|---|---|
| 0xC19AA6E5, | 0xAE996137, | 0xEBAD2394, | 0xDABC9CF9, | 0x58587324, | 0xF5266C20, | 0x968235EC, |
| 0x9DB14551, | 0xB393E953, | 0xCED63EB1, | 0x28706A82, | 0x9498E453, | 0x920A9041, | 0x7AB82595, |
| 0xF7CCC036, | 0x43608CDC, | 0x6CACD32A, | 0x8CA6B79D, | 0x89000EA0, | 0xA902E820, | 0x89BD161F, |
| 0x1E8A2BA9, | 0xFCA5B817, | 0x52729E51, | 0x16A6BAB7, | 0xD0C30227, | 0x34B079E8, | 0xB4565FC7, |
| 0xA10DF77A, | 0xFEEF1869, | 0xF23E4AF2, | 0x6F3BB9FC | | | |

) ;
C0[32] =
(

| | | | | | | |
|---|---|---|---|---|---|---|
| 0x75727423, | 0xA13494D1, | 0xCFA2B2A7, | 0xC550BC7F, | 0xDAED1651, | 0x406A4D5C, | 0xFA4C4E37, |
| 0xAE9DFCE3, | 0x604CD926, | 0x359AA9F0, | 0x31463A24, | 0xAB364B70, | 0xAD49D382, | 0xA527E9F1, |
| 0x4F83AC97, | 0xAE804824, | 0x74D3201F, | 0xF393FE70, | 0xBE4C2C49, | 0x3C65A193, | 0x9B03F0B9, |
| 0x98B50EF3, | 0x93EC79CD, | 0x1EA18628, | 0x8EE8CAB2, | 0xE4D40BF9, | 0xEA1039A7, | 0xBFFC42E0, |
| 0x7841046C, | 0x03F07BD1, | 0xF6A6FEAD, | 0x2AAEA815 | | | |

) ;

(2) Increase the number of final rounds, e.g., provide 7 final rounds instead of 3 as in the Shabal P permutation.

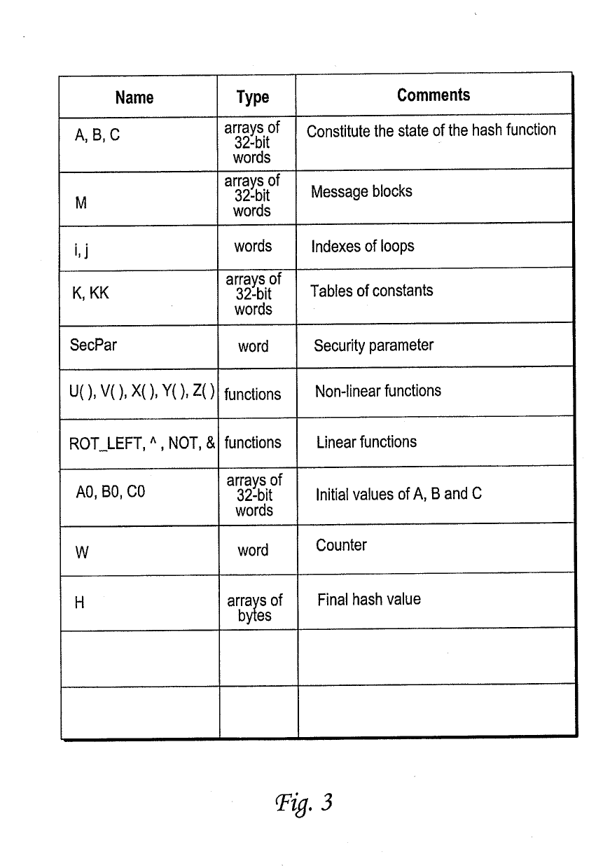

FIG. 3 shows variables and parameters for the above pseudo code with their type and explanatory comments. The above pseudo code does not include the Shabal mode of operation as explained above, or the remainder of the hash function and which is well known, with the conventional subsequent steps of using the computed digest H, which means comparing the computed digest to the digest that conventionally accompanies the message to verify the message.

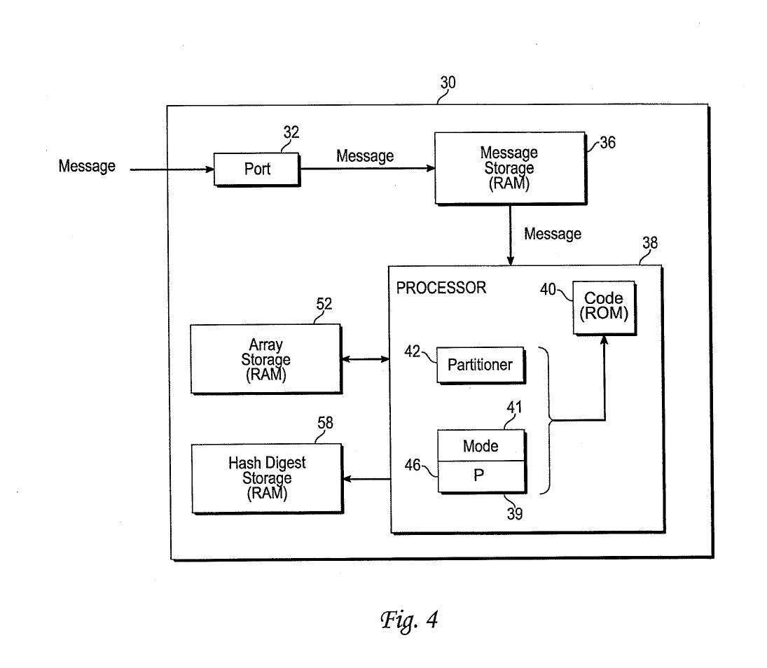

FIG. 4 shows in a block diagram relevant portions of a computing device (system) 30 in accordance with the invention. This is, e.g., a computer, mobile telephone, Smart Phone, personal digital assistant or similar device, or part of such a device and includes conventional hardware components executing in one embodiment software (computer code) as represented by the above pseudo-code examples. This code may be, e.g., in the C or C++ computer language or its functionality may be expressed in the form of firmware or hardware logic of the type described above; writing such code or designing such logic would be routine in light of the above pseudo code. Of course, the above pseudo code example for function P is not limiting.

The computer code is conventionally stored in code memory (computer readable storage medium, e.g., ROM) 40 (as object code or source code) associated with processor 38 for execution by processor 38. The incoming message to be hashed is received at port 32 and stored in computer readable storage medium (memory, e.g., RAM) 36 where it is coupled to processor 38. Processor 38 conventionally partitions the message into suitable sized blocks at software partitioning module 42. Other software (code) modules in processor 38 include the hash function algorithm module 46 which carries out the code functionality set forth above for the P function 39 and further includes code for the Shabal mode of operation 41. Coding software for the Shabal mode of operation 41 would be routine.

Also coupled to processor 38 are the P function computer readable storage medium (memory) 52, as well as a third storage 58 for the resulting hash digest. Storage locations 36, 52, 58 may be in one or several conventional physical memory devices (such as semiconductor RAM or its variants or a hard disk drive).

Electric signals conventionally are carried between the various elements of FIG. 4. Not shown in FIG. 4 is the subsequent conventional use of the resulting hash digest, which is compared by processor 38 to a second expected hash value associated with the message and conventionally transmitted therewith. Only if the two hash values match is the message (a digital document, digital signature or similar information) authenticated.

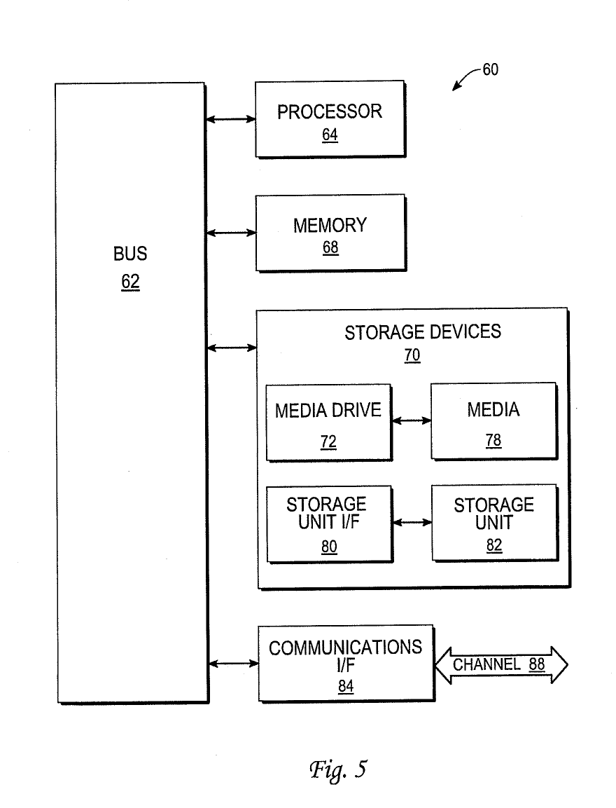

FIG. 5 shows further detail of the computing device in one embodiment. FIG. 5 illustrates a typical and conventional computing system 60 that may be employed to implement processing functionality in embodiments of the invention and shows additional detail of the FIG. 3 system. Computing systems of this type may be used in a computer server or user (client) computer or other computing device, for example. Those skilled in the relevant art will also recognize how to implement embodiments of the invention using other computer systems or architectures. Computing system 60 may represent, for example, a desktop, laptop or notebook computer, hand-held computing device (personal digital assistant (PDA), cell phone, palmtop, etc.), mainframe, server, client, or any other type of special or general purpose computing device as may be desirable or appropriate for a given application or environment. Computing system 60 can include one or more processors, such as a processor 64 (equivalent to processor 38 in FIG. 4). Processor 64 can be implemented using a general or special purpose processing engine such as, for example, a microprocessor, microcontroller or other control logic. In this example, processor 64 is connected to a bus 62 or other communications medium.

Computing system 60 can also include a main memory 68 (equivalent to memories 36, 58), such as random access memory (RAM) or other dynamic memory, for storing information and instructions to be executed by processor 64. Main memory 68 also may be used for storing temporary variables or other intermediate information during execution of instructions to be executed by processor 64. Computing system 60 may likewise include a read only memory (ROM) or other static storage device coupled to bus 62 for storing static information and instructions for processor 64.

Computing system 60 may also include information storage system 70, which may include, for example, a media drive 62 and a removable storage interface 80. The media drive 72 may include a drive or other mechanism to support fixed or removable storage media, such as flash memory, a hard disk drive, a floppy disk drive, a magnetic tape drive, an optical disk drive, a compact disk (CD) or digital versatile disk (DVD) drive (R or RW), or other removable or fixed media drive. Storage media 78 may include, for example, a hard disk, floppy disk, magnetic tape, optical disk, CD or DVD, or other fixed or removable medium that is read by and written to by media drive 72. As these examples illustrate, the storage media 78 may include a computer-readable storage medium having stored therein particular computer software or data.

In alternative embodiments, information storage system 70 may include other similar components for allowing computer programs or other instructions or data to be loaded into computing system 60. Such components may include, for example, a removable storage unit 82 and an interface 80, such as a program cartridge and cartridge interface, a removable memory (for example, a flash memory or other removable memory module) and memory slot, and other removable storage units 82 and interfaces 80 that allow software and data to be transferred from the removable storage unit 78 to computing system 60.

Computing system 60 can also include a communications interface 84 (equivalent to port 32 in FIG. 4). Communications interface 84 can be used to allow software and data to be transferred between computing system 60 and external devices. Examples of communications interface 84 can include a modem, a network interface (such as an Ethernet or other network interface card (NIC)), a communications port (such as for example, a USB port), a PCMCIA slot and card, etc. Software and data transferred via communications interface 84 are in the form of signals which can be electronic, electromagnetic, optical or other signals capable of being received by communications interface 84. These signals are provided to communications interface 84 via a channel 88. This channel 88 may carry signals and may be implemented using a wireless medium, wire or cable, fiber optics, or other communications medium. Some examples of a channel include a phone line, a cellular phone link, an RF link, a network interface, a local or wide area network, and other communications channels.

In this disclosure, the terms “computer program product,” “computer-readable medium” and the like may be used generally to refer to media such as, for example, memory 68, storage device 78, or storage unit 82. These and other forms of computer-readable media may store one or more instructions for use by processor 64, to cause the processor to perform specified operations. Such instructions, generally referred to as “computer program code” (which may be grouped in the form of computer programs or other groupings), when executed, enable the computing system 60 to perform functions of embodiments of the invention. Note that the code may directly cause the processor to perform specified operations, be compiled to do so, and/or be combined with other software, hardware, and/or firmware elements (e.g., libraries for performing standard functions) to do so.

In an embodiment where the elements are implemented using software, the software may be stored in a computer-readable medium and loaded into computing system 60 using, for example, removable storage drive 74, drive 72 or communications interface 84. The control logic (in this example, software instructions or computer program code), when executed by the processor 64, causes the processor 64 to perform the functions of embodiments of the invention as described herein.

This disclosure is illustrative and not limiting. Further modifications will be apparent to these skilled in the art in light of this disclosure and are intended to fall within the scope of the appended claims.

We claim:

1. A hashing method performed by a computing apparatus and comprising the acts of:
(a) receiving a message at an input port;
(b) storing the received message at a first computer readable storage medium coupled to the input port;
(c) partitioning the received message into a plurality of portions;
(d) applying a pre-determined mode of operation to a function having pre-steps, left shift steps, and final steps and storing a set of values representing three arrays of data in a second computer readable storage medium coupled to the processor;
(e) updating each array by applying the array and one portion of the message to the function, wherein the function computes the updated first array from the second array, without applying any of the message portions in each of the pre-steps, left shift steps, and final steps;
(f) repeating acts (d) and (e) for a plurality of the message portions;
(g) using the updated second array resulting from act (f) to provide a hash value of the message; and
(h) the processor storing the hash value in a third computer readable storage medium.

2. The method of claim 1, wherein each of the three arrays is 32 words of 32 bits.

3. The method of claim 1, wherein the predetermined mode of operation is that of the Shabal hash function.

4. The method of claim 1, wherein the function includes providing an index, and rotating bits in the second array as a function of the index.

5. The method of claim 1, wherein the function includes an index, and modifying an order of words of the first array is a function of the index.

6. The method of claim 4, wherein the updating of the second array is also a function of a current message portion.

7. The method of claim 1, wherein the function includes logically combining a current portion of the message with the second array, wherein the second array is updated as a function of the first array modulo 257.

8. The method of claim 1, further comprising, in act (e) for the pre-steps, updating the first and second arrays, without applying any of the message portions.

9. The method of claim 1, further comprising, in act (e) in the pre-steps, logically combining the second array with a constant.

10. The method of claim 8, wherein updating the first and second arrays in the left shift steps includes adding to each array a non-linear function.

11. The method of claim 1, further comprising, in act (f) for the final steps, applying at least seven rounds of the function.

12. The method of claim 11, wherein the function further includes in the final steps adding to each of the first and second arrays a non-linear constant.

13. The method of claim 3, wherein an initial value of each of the arrays differs from that of the Shabal hash function.

14. The method of claim 1, further comprising the acts of:
receiving a hash value associated with the message at the processor;
comparing the received hash value to the stored hash value of act (g); and
authenticating the message if the comparison indicates a match.

15. The method of claim 1, wherein the message is one of a digital signature or document, a digital message, a secret key or an identifier.

16. A computer readable medium storing computer code instructions for executing the method of claim 1 on the computing apparatus.

17. An apparatus for computing a hash, comprising:
(a) an input port for receiving a message;
(b) a first computer readable storage medium coupled to the input port for storing the received message; and
(c) a processor coupled to the first storage medium and which partitions the stored message into a plurality of portions;
(d) wherein the processor applies a pre-determined mode of operation to a function having pre-steps, left shift steps, and final steps and the processor stores a set of values representing three arrays of data in a second computer readable storage medium coupled to the processor;
(e) wherein the processor updates each array by applying the array and one portion of the message to the function, wherein the function computes the updated first array from the second array, without applying any of the message portions in each of the pre-steps, left shift steps, and final steps;
(f) wherein the processor repeats (d) and (e) for a plurality of the message portions;
(g) wherein the processor uses the second array resulting from (f) to provide a hash value of the message; and
(h) wherein the processor stores the hash value in a third computer readable storage medium coupled to the processor.

18. The apparatus of claim 17, wherein each of the three arrays is 32 words of 32 bits.

19. The apparatus of claim 17, wherein the predetermined mode of operation is that of the Shabal hash function.

20. The apparatus of claim 17, wherein the function includes providing an index, and rotating bits in the second array as a function of the index.

21. The apparatus of claim 17, wherein the function includes an index, and modifying an order of words of the first array is a function of the index.

22. The apparatus of claim 17, wherein the updating of the second array is also a function of a current message portion.

23. The apparatus of claim 17, wherein the function includes logically combining a current portion of the message with the second array, wherein the second array is updated as a function of the first array modulo 257.

24. The apparatus of claim 17, further comprising, in (e) for the pre-steps, updating the first and second arrays, without applying any of the message portions.

25. The apparatus of claim 17, further comprising, in (e) for the pre-steps, logically combining the second array with a constant.

26. The apparatus of claim 24, wherein updating the first and second arrays in the left shift steps includes adding to each a non-linear function.

27. The apparatus of claim 17, further comprising, in (f) for the final steps, applying at least seven rounds of the function.

28. The apparatus of claim 27, wherein the function further includes in the final steps adding to each of the first and second arrays a non-linear constant.

29. The apparatus of claim 19, wherein an initial value of each of the arrays differs from that of the Shabal hash function.

30. The apparatus of claim 17, further comprising the acts of:
receiving a hash value associated with the message at the processor;
comparing the received hash value to the stored hash value of act (g); and
authenticating the message if the comparison indicates a match.

31. The apparatus of claim 17, wherein the message is one of a digital signature or document, a digital message, a secret key or an identifier.
